(19) United States
(12) Patent Application Publication
(10) Pub. No.: US 2002/0075380 A1
(43) Pub. Date: Jun. 20, 2002

(54) Apparatus for outputting laser beam

(75) Inventor: Yukihisa Takeuchi, Nishikamo-gun (JP)

Correspondence Address: BURR & BROWN, PO BOX 7068, SYRACUSE, NY, 13261-7068, US

(73) Assignee: NGK Insulators, Ltd.

(21) Appl. No.: 09/918,367

(22) Filed: Jul. 30, 2001

(30) Foreign Application Priority Data
Aug. 11, 2000 (JP) 2000-243,928

(51) Int. Cl. B41J 2/47

(52) U.S. Cl. 347/255; 347/239

(57) ABSTRACT

An apparatus for outputting a laser beam includes a laser beam source and laser beam diameter adjusting means for adjusting a diameter of a beam incident from the laser beam source. The apparatus also includes laser beam reflecting direction controlling means for controlling a reflecting direction of the beam incident from the laser beam diameter adjusting means, and recording means for recording information data in accordance with the diameter of the beam incident from the laser beam reflection direction controlling means.

### BACKGROUND OF THE INVENTION

1. Technical Field

This invention relates to an apparatus for outputting a laser beam, having a microoptical element for modulating a light into a dot pattern rapidly and/or collecting a light.

2. Background Art

With development of optical technique, especially laser beam technique, an apparatus for outputting an image, such as printer or machine tool is put into practical use. For example, in case of a laser beam printer, the laser beam is emitted from a gas laser, a semiconductor laser or the like, and is modulated and deflected at an order of MHz to form an electrostatic latent image pattern on a photosensitive body, which is then subjected to development process with a toner material, to thereby record a character, an image or the like on a sheet-like record carrier, typically paper.

As the modulation of the beam is generally performed by an on-off control of the beam, the resulting image output is in the form of a dot record of two values, and any pattern can be formed by a set of micro dots. In such a laser printer, as a gradation rendering method, an area modulating method is used, wherein an area ratio of the dots is changed by changing the number of dots per micro unit area. The area modulation method is also called as “quasi-middle tone rendering method”. However, in the area modulation method, the concentration of the middle tone is discrete, and there tends to occur a concentration jump emphasizing discontinuity of the gradation and degradation of the gradation rendering due to saturation of the concentration.

Another method of performing gradation is proposed, in which the strength of the beam is modulated at several levels and the thickness of the toner material is controlled. However, this method is not suitable for performing a stable recording.

### DISCLOSURE OF THE INVENTION

It is an object of the present invention to provide an apparatus for outputting a laser beam, having a satisfactory gradation rendering property and capable of performing a stable recording.

According to one aspect of the present invention, there is provided an apparatus for outputting a laser beam comprising: a laser beam source; laser beam diameter adjusting means for adjusting a diameter of a beam incident from the laser beam source; laser beam reflecting direction controlling means for controlling a reflecting direction of the beam incident from the laser beam diameter adjusting means; and recording means for recording information data in accordance with the diameter of the beam incident from the laser beam reflection direction controlling means.

With the above-mentioned arrangement according to the present invention, as the diameter of the beam is adjusted by the laser beam diameter adjusting means, it is possible to modulate a dot diameter rapidly and continuously. As a result, it is possible to realize an apparatus for outputting the laser beam having a good gradation rendering property. It is also possible to perform a stable recording because it is not necessary to modulate the strength of the laser beam and/or to control the thickness of the toner material when performing the gradation.

For example, the laser beam diameter adjusting means comprises: a piezoelectric/electrostrictive film type element comprising: a substrate; a piezoelectric/electrostrictive operating section integrated onto the substrate; and a reflective surface associated with the piezoelectric/electrostrictive film type element.

According to another aspect of the present invention, there is provided an apparatus for outputting a laser beam comprising: a laser beam source; laser beam diameter adjusting means for adjusting a diameter of a beam incident from the laser beam source; laser beam reflecting direction controlling means for controlling a reflecting direction of the beam incident from the laser beam diameter adjusting means; and recording means for recording information data in accordance with the diameter of the beam incident from the laser beam reflection direction controlling means; wherein the laser beam diameter adjusting means comprises: a piezoelectric/electrostrictive film type element comprising: a substrate; a piezoelectric/electrostrictive operating section integrated onto the substrate; and a reflective surface associated with the piezoelectric/electrostrictive film type element.

Preferably, the substrate of the piezoelectric/electrostrictive film type element has a relatively thin and flexible sheet section and a peripheral section surrounding the sheet section, the peripheral section being relatively rigid and thicker than the sheet section, and wherein the piezoelectric/electrostrictive operating section is arranged on the sheet section of the substrate.

The piezoelectric/electrostrictive operating section may comprise: a first electrode arranged on the sheet section; a piezoelectric/electrostrictive layer arranged on the first electrode; a second electrode arranged on the piezoelectric/electrostrictive layer, the second electrode being capable of applying an electric field to the piezoelectric/electrostrictive layer in cooperation with the first electrode; and wherein the reflective surface is formed by a layer that is arranged on the second electrode.

Alternatively, the piezoelectric/electrostrictive operating section may comprise: a first electrode arranged on one face, i.e. front face or back face of the sheet section; a piezoelectric/electrostrictive layer arranged on the first electrode; a second electrode arranged on the piezoelectric/electrostrictive layer, the second electrode being capable of applying an electric field to the piezoelectric/electrostrictive layer in cooperation with the first electrode; and wherein the reflective surface is formed by a layer that is arranged on the other face, i.e. back face or front face of the sheet section.

In either case, the sheet section deforms into a convex shape or a concave shape by a piezoelectric/electrostrictive effect occurred when applying an electric field to the piezoelectric/electrostrictive layer. Therefore, by controlling such an electric field, it is possible to achieve a variable degree of the deformation of the sheet section, and thus adjust a focal length or a diameter of the beam reflected by the reflective layer.

Also, as the piezoelectric/electrostrictive body has a film shape, it is possible to drive the laser beam diameter adjusting mean at a relatively low driving voltage. By such a structure, a speed of response increases, therefore, it is possible to drive the laser beam diameter adjusting means at a relatively high speed.

The piezoelectric/electrostrictive operating section may comprise: a first electrode arranged on the sheet section; a piezoelectric/electrostrictive layer arranged on the first electrode; and a second electrode arranged on the piezoelectric/electrostrictive layer, the second electrode being capable of applying an electric field to the piezoelectric/electrostrictive layer in cooperation with the first electrode, wherein the second electrode forms the reflective surface.

In this case, the second electrode also serves as the reflective layer, it is possible to constitute the apparatus for outputting the laser beam which has a good degradation rendering property and can perform a stable recording more easily.

The apparatus may further comprises at least one of: a first optical system arranged an optical path between the laser beam source and the laser beam diameter adjusting means; and a second optical system arranged an optical path between the laser beam reflecting direction controlling means and the recording means.

The present invention will be further explained below with reference to a preferred embodiment shown in the accompanying drawings.

### BRIEF DESCRIPTION OF THE DRAWINGS

FIG. 1 is a view showing an embodiment of an apparatus for outputting a laser beam according to the present invention;

FIG. 2 is a top view of a microoptical element of FIG. 1;

FIG. 3 is a sectional view of the microoptical element taken along the lines I-I of FIG. 2; and

FIGS. 4A to 4H are views explaining the operation of the microoptical element of FIG. 1.

### BEST MODE FOR CARRYING OUT THE INVENTION

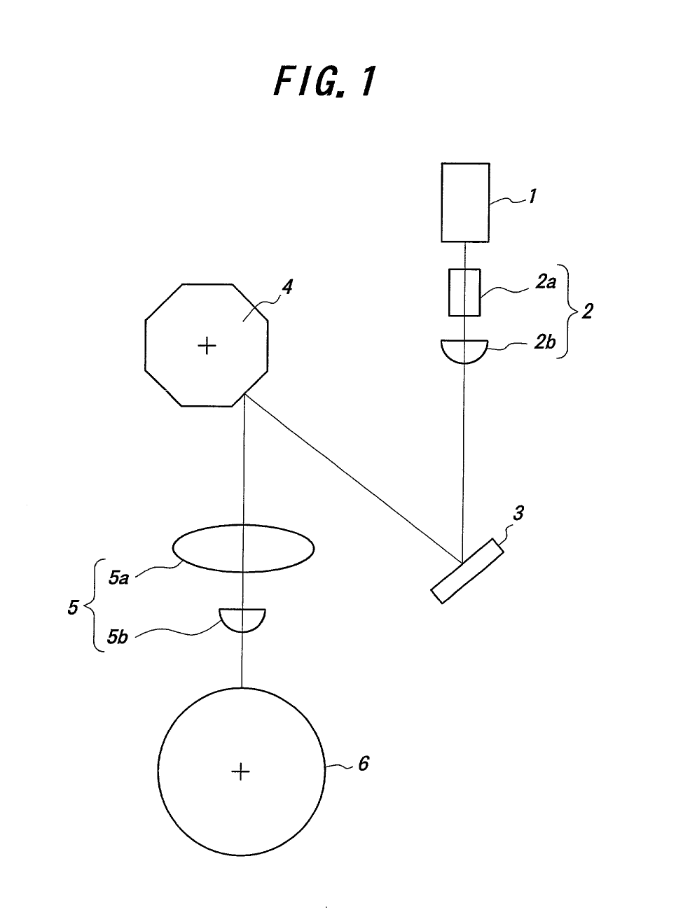

FIG. 1 is a view showing an embodiment of an apparatus for outputting a laser beam according to the present invention, which is in the form of a laser beam printer. The laser beam printer comprises a laser beam source 1, a first optical system 2 through which the beam incident from the source 1 passes, a microoptical element 3 for adjusting the diameter of the beam incident from the first optical system 2, a polygon mirror 4 for controlling the reflecting direction of the beam incident from the microoptical element 3, a second optical system 5 through which the beam incident from the polygon mirror 4 passes, a photosensitive drum 6 for recording information data in accordance with the diameter of the beam incident from the second optical system 5. The source 1 may be realized as any type of a laser, such as gas laser or semiconductor laser. A flush modulation timing for the beam generated from the source 1 is controlled by a timing control circuit, which is not shown in FIG. 1. The first optical system 2 has a collimate optical system 2a through which the beam from the source passes, and a cylinder lens 2b through the beam from the collimate optical system 2a passes. The microoptical element 3 adjusts the diameter of the beam from the first optical system 1 by the timing control circuit which is not shown in FIG. 1 in synchronous with the modulation timing of the beam generated from the source 1. The polygon mirror 4 reflects the beam incident from the microoptical element 3 to a desired position of the photosensitive drum 6 by a revolution of itself. The second optical system 5 has an fθ lens 5a through which the beam from the polygon mirror 4 passes, and a cylinder lens 5b through which the beam from the fθ lens 5a passes.

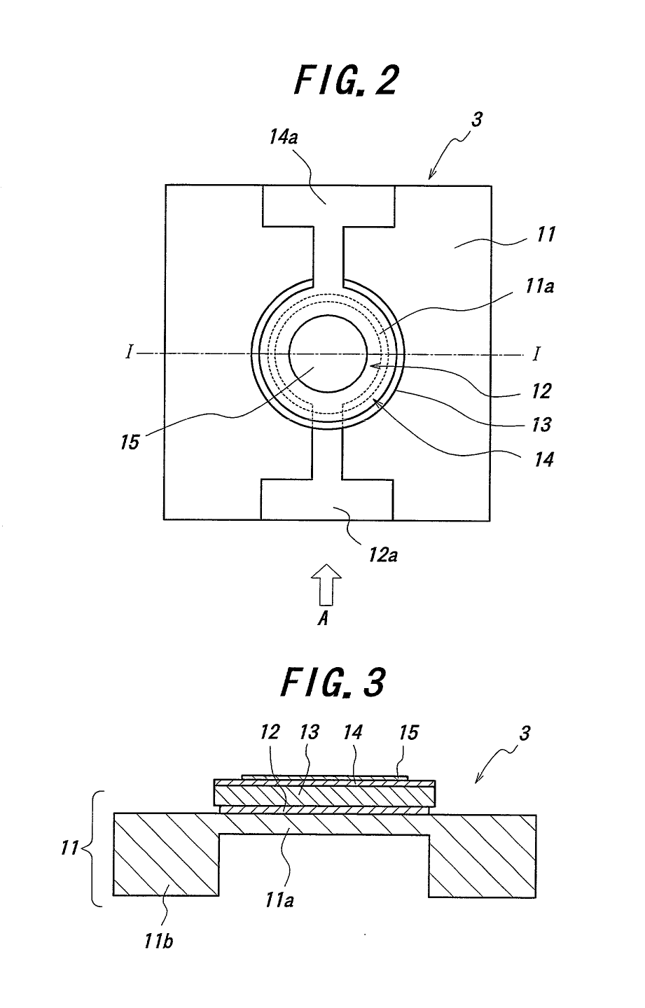

FIG. 2 is a top view of a microoptical element of FIG. 1, and FIG. 3 is a sectional view of the microoptical element taken along the lines I-I of FIG. 2. The microoptical element comprises: a substrate 11 having a relatively thin and flexible sheet section 11a and a peripheral section 11b surrounding the sheet section 11a, the peripheral section 11b being relatively rigid and thicker than the sheet section 11a; a lower electrode 12 as the first electrode arranged on the sheet section 11a; a piezoelectric/electrostrictive layer 13 arranged on the lower electrode 12; an upper electrode 14 as the second electrode arranged on the piezoelectric/electrostrictive layer 13, the upper electrode 14 being capable of applying an electric field to the piezoelectric/electrostrictive layer 13 in cooperation with the lower electrode 12; and a reflective layer 15 arranged on the upper electrode 14 and reflecting the beam to a direction of the polygon mirror 4.

In this case, the microoptical element 3 is formed as a integrated body by providing the lower electrode 12, the piezoelectric/electrostrictive layer 13, the upper electrode 14 and the reflective layer 15 subsequently using a conventional method of forming layers.

Preferably, the substrate 11 is composed of a heat-resistant, chemically stabile and insulating material because a joint of at least one of the lower electrode 12, the piezoelectric/electrostrictive layer 13 and the upper electrode 14 may be performed by a thermal treatment without an adhesive as described below and a condition at a remarkable high temperature may be occur especially when reflecting the beam.

In view of above-mentioned situation, it is preferable to use a ceramics as a material of the substrate 11. Such a ceramics includes, for example, stabilized zirconium oxide, aluminum oxide, magnesium oxide, titanium oxide, mullite, aluminum nitride, silicon nitride, glass, or the like. Among them, it is more preferable to use the stabilized zirconium oxide because it is possible to maintain relatively high mechanical strength even if the sheet section 11a has a relatively small thickness by the stabilized zirconium, and the stabilized zirconium oxide has an excellent toughness.

The thickness of the sheet section 11a is generally not more than 50 μm, preferably not more than 30 μm, and more preferably not more than 15 μm. The sheet section 11a may have any type of shapes, and preferably has a circular shape as shown in FIG. 2 if it is required to have a symmetry of the beam reflected by itself. If the sheet section 11a has the circular shape, a diameter of the sheet section 11a is generally between 10 μm and 1 mm, preferably 50 μm and 500 μm. The diameter of the sheet section 11a is selected in accordance with a necessary driving frequency and the diameter of the beam.

The front face of the lower electrode 12 is slightly smaller than the back face of the piezoelectric/electrostrictive layer 13 so as to entirely contact the front face of the lower electrode 12 to the back face of the piezoelectric/electrostrictive layer 13. Preferably, a shape and an area of the back face of the lower electrode 12 is substantially same as those of the front face of the sheet section 11a so that a shape of the sheet section is smoothly deformed into a concave or convex shape and thus an appropriate element as a mirror can be obtained. The lower electrode 12 has a terminal 12a for connecting to the timing control circuit which is not shown in FIG. 2.

As a material composed of the lower electrode 12, a conductive material exhibiting a good joining property to both the substrate 11 and the piezoelectric/electrostrictive layer 13 is used. Concretely, platinum, palladium, silver or an electrode material containing silver-palladium alloy, silver-platinum alloy or platinum-palladium alloy as a major component or components are preferably used, especially if a thermal treatment is performed when forming the piezoelectric/electrostrictive layer 13, platinum or an alloy containing platinum as a major component or components are preferably used.

The lower electrodes 12 is formed by the use of any film forming method comprising various kinds of thin-film forming methods such as ion-beam, sputtering, vacuum vapor deposition, CVD, ion plating, and plating, and various kinds of thick-film forming methods such as screen printing, spray, dipping. Among them, especially, the sputtering and the screen printing are preferably employed. The lower electrode 12 is heated as required so as to be integrated into one body with the substrate 11.

The piezoelectric/electrostrictive layer 13 may comprise any material exhibiting piezoelectric/electrostrictive property. Such a material can be ceramic piezoelectric/electrostrictive material of lead system such as lead zirconate, lead titanate, lead titanate zirconate (PZT) or the like; barium titanate and ceramic ferroelectrics of barium system containing the barium titanate as a major component; polymer piezoelectric body such as poly (vinylidene fluoride) (PVDF); or ceramic piezoelectric body of Bi system or Bi layer structure compound such as (Bi_{0.5}Na_{0.5})TiO₃. Of course, mixture thereof, solid solution and the solid solution with additive improving piezoelectric/electrostrictive property may be used. In the embodiment, a material of PZT system exhibiting relatively high piezoelectric property is preferably used.

When forming the piezoelectric/electrostrictive layer 13, also, any film forming method is used similar as forming of the lower electrode 12, among them, the screen printing are preferably employed in view of low cost.

The piezoelectric/electrostrictive layer 13 formed on the lower electrode 12 is heated as required so as to be integrated into one body with the lower electrode 12. When a ceramic material is used as a piezoelectric/electrostrictive material, the piezoelectric/electrostrictive layer 13 is heated at the temperature between 900° C. and 1400° C., preferably between 1000° C. and 1400° C. In this case, it is preferable to control atmosphere around the piezoelectric/electrostrictive material in cooperate with a vaporization source of the piezoelectric/electrostrictive material and heat the piezoelectric/electrostrictive layer 13 so that the piezoelectric/electrostrictive layer 13 may not be unstable at the relatively high temperature.

A front face of the piezoelectric/electrostrictive layer 13 is polished as required so as to restrict a scattering of the beam or any other light and achieve a relatively high reflectance.

The upper electrode 14 is slightly larger than a front face of the lower electrode 12, and is slightly smaller than the front face of the piezoelectric/electrostrictive layer 13. The back face of the upper electrode 14 entirely contacts the front face of the piezoelectric/ electrostrictive layer 13. Thereby, a short-circuit between the lower electrode 12 and the upper electrode 14 is prevented.

As a material composed of the upper electrode 14, a conductive material exhibiting a good joining property to the piezoelectric/electrostrictive layer 13 is used. Concretely, silver, gold, copper or alloy thereof is used. The upper electrode 14 may be formed by a similar method of forming the lower electrode 12.

The upper electrode 14 formed on the piezoelectric/electrostrictive layer 13 is heated as required, and jointed the piezoelectric/electrostrictive layer 13 and an auxiliary electrode not shown in FIGS. 2 and 3 so as to be integrated into one body with the piezoelectric/electrostrictive layer 13 and the auxiliary electrode.

When the substrate 11, the lower electrode 12, the piezoelectric/electrostrictive layer 13 and the upper electrode 14 are jointed each other, a heat treatment is performed each time after the lower electrode 12, the piezoelectric/electrostrictive layer 13 or the upper electrode 14 are formed, or after all of the lower electrode 12, the piezoelectric/electrostrictive layer 13 and the upper electrode 14 are formed. Of course, during the heat treatment, a appropriate temperature at the heat treatment is selected so as to maintain a good joining property and restrict a change in quality due to a scattering of constitutive element.

The reflective layer 15 is composed of a material having a good reflective property, is preferably composed of a metal having a relatively high reflectance such as aluminium, copper, molybudenum or the like, and is more preferably composed of aluminium. Further, the reflective layer 15 having about ½ to 1/10 of a surface roughness to an incident beam is formed so as to reduce a scattering loss of the incident beam. The reflective layer 15 is formed by a similar method of forming the lower electrode 12 and the upper electrode 14, and preferably formed by the vacuum vapor deposition or the sputtering because it is necessary to maintain a substantially little surface roughness of the reflective layer 15.

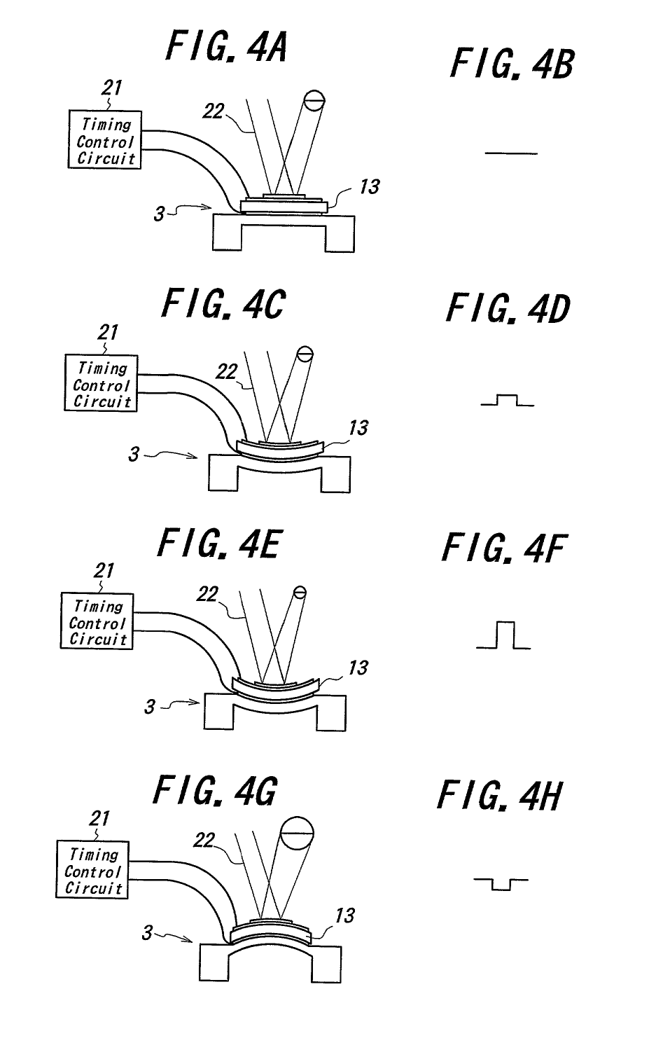

The operation of the microoptical element will be explained with reference to FIG. 4. The microoptical element 3 is driven at a drive voltage from −10 V to 70 V by a timing control circuit 21. The drive voltage is appropriately selected in accordance with a thickness of the piezoelectric/electrostrictive layer 13 and a diameter of the laser beam.

If a level of a signal input from the timing control circuit 21 to the microoptical element 3 is zero, as shown in FIG. 4A, the microoptical element 3 is not deformed viewing from an A direction shown in FIG. 2. As a result, the diameter of the beam 22 does not change even after the beam 22 is reflected by the microoptical element 3. A signal waveform input to the microoptical element 3 in this case is shown in FIG. 4B.

If the signal has a positive level with a relatively small absolute value, as shown in FIG. 4C, the microoptical element 3 is deformed into a concave shape viewing from the A direction. As a result, the diameter of the beam 22 is reduced after the beam 22 is reflected by the microoptical element 3. The signal waveform in this case is shown in FIG. 4D.

If the signal has a positive level with a relatively large absolute value, as shown in FIG. 4E, a degree of deformation to the concave shape of the microoptical element 3 viewing from the A direction is higher than that as shown in FIG. 4C, and the diameter of the beam 22 reflected by the microoptical element 3 is smaller than that as shown in FIG. 4C. A signal waveform in this case is shown in FIG. 4F.

If the signal has a negative level, as shown in FIG. 4G, the microoptical element 3 is deformed into a convex shape viewing from the A direction. As a result, the diameter of the beam 22 is increased after the beam 22 is reflected by the microoptical element 3. A signal waveform in this case is shown in FIG. 4H.

While the present invention has been described above with reference to a certain preferred embodiment, it should be noted that it was presented by way of an example only and various changes and/or modifications may be made without departing from the scope of the invention. For example, the laser beam printer as the apparatus for outputting the laser beam is explained in the embodiment, however, any kind of the apparatus is applied to the present invention.

In the embodiment, at least one of the first optical system and the second optical system can be constituted by any other optical system, or at least one of the first optical system and the second optical system can be omitted.

The reflective layer may be arranged on a back face of the sheet section instead of a front face of the upper electrode. In this case, the beam is incident toward a direction of the back face of the sheet section.

The reflective layer may be omitted and the upper electrode may serve as the reflective layer. In this case, the upper electrode comprises a similar material composed of the reflective layer.

1. An apparatus for outputting a laser beam comprising:
a laser beam source;
laser beam diameter adjusting means for adjusting a diameter of a beam incident from said laser beam source;
laser beam reflecting direction controlling means for controlling a reflecting direction of the beam incident from said laser beam diameter adjusting means; and
recording means for recording information data in accordance with said diameter of the beam incident from said laser beam reflection direction controlling means.

2. The apparatus according to claim 1, wherein said laser beam diameter adjusting means comprises:
a piezoelectric/electrostrictive film type element comprising:
a substrate;
a piezoelectric/electrostrictive operating section integrated onto said substrate; and
a reflective surface associated with said piezoelectric/electrostrictive film type element.

3. The apparatus according to claim 2, wherein said substrate of the piezoelectric/electrostrictive film type element has a relatively thin and flexible sheet section and a peripheral section surrounding said sheet section, said peripheral section being relatively rigid and thicker than said sheet section, and wherein said piezoelectric/electrostrictive operating section is arranged on said sheet section of the substrate.

4. The apparatus according to claim 3, wherein said piezoelectric/electrostrictive operating section comprises:
a first electrode arranged on said sheet section;
a piezoelectric/electrostrictive layer arranged on said first electrode;
a second electrode arranged on said piezoelectric/electrostrictive layer, said second electrode being capable of applying an electric field to said piezoelectric/electrostrictive layer in cooperation with said first electrode; and wherein said reflective surface is formed by a layer that is arranged on said second electrode.

5. The apparatus according to claim 3, wherein said piezoelectric/electrostrictive operating section comprises:
a first electrode arranged on one face of said sheet section;
a piezoelectric/electrostrictive layer arranged on said first electrode;
a second electrode arranged on said piezoelectric/electrostrictive layer, said second electrode being capable of applying an electric field to said piezoelectric/electrostrictive layer in cooperation with said first electrode; and
wherein said reflective surface is formed by a layer that is arranged on the other face of said sheet section.

6. The apparatus according to claim 3, wherein said piezoelectric/electrostrictive operating section comprises:
a first electrode arranged on said sheet section;
a piezoelectric/electrostrictive layer arranged on said first electrode; and
a second electrode arranged on said piezoelectric/electrostrictive layer, said second electrode being capable of applying an electric field to said piezoelectric/electrostrictive layer in cooperation with said first electrode, wherein said second electrode forms said reflective surface.

7. The apparatus according to claim 1, further comprising at least one of:
a first optical system arranged an optical path between said laser beam source and said laser beam diameter adjusting means; and
a second optical system arranged an optical path between said laser beam reflecting direction controlling means and said recording means.

8. An apparatus for outputting a laser beam comprising:
a laser beam source;
laser beam diameter adjusting means for adjusting a diameter of a beam incident from said laser beam source;
laser beam reflecting direction controlling means for controlling a reflecting direction of the beam incident from said laser beam diameter adjusting means; and
recording means for recording information data in accordance with said diameter of the beam incident from said laser beam reflection direction controlling means;
wherein said laser beam diameter adjusting means comprises:
a piezoelectric/electrostrictive film type element comprising:
a substrate;
a piezoelectric/electrostrictive operating section integrated onto said substrate; and
a reflective surface associated with said piezoelectric/electrostrictive film type element.

9. The apparatus according to claim 8, wherein said substrate of the piezoelectric/electrostrictive film type element has a relatively thin and flexible sheet section and a peripheral section surrounding said sheet section, said peripheral section being relatively rigid and thicker than said sheet section, and wherein said piezoelectric/electrostrictive operating section is arranged on said sheet section of the substrate.

10. The apparatus according to claim 9, wherein said piezoelectric/electrostrictive operating section comprises:
a first electrode arranged on said sheet section;
a piezoelectric/electrostrictive layer arranged on said first electrode;
a second electrode arranged on said piezoelectric/electrostrictive layer, said second electrode being capable of applying an electric field to said piezoelectric/electrostrictive layer in cooperation with said first electrode; and
wherein said reflective surface is formed by a layer that is arranged on said second electrode.

11. The apparatus according to claim 9, wherein said piezoelectric/electrostrictive operating section comprises:
a first electrode arranged on one face of said sheet section;
a piezoelectric/electrostrictive layer arranged on said first electrode;
a second electrode arranged on said piezoelectric/electrostrictive layer, said second electrode being capable of applying an electric field to said piezoelectric/electrostrictive layer in cooperation with said first electrode; and
wherein said reflective surface is formed by a layer that is arranged on the other face of said sheet section.

12. The apparatus according to claim 9, wherein said piezoelectric/electrostrictive operating section comprises:
a first electrode arranged on said sheet section;
a piezoelectric/electrostrictive layer arranged on said first electrode; and
a second electrode arranged on said piezoelectric/electrostrictive layer, said second electrode being capable of applying an electric field to said piezoelectric/electrostrictive layer in cooperation with said first electrode, wherein said second electrode forms said reflective surface.

13. The apparatus according to claim 8, further comprising at least one of:
a first optical system arranged an optical path between said laser beam source and said laser beam diameter adjusting means; and
a second optical system arranged an optical path between said laser beam reflecting direction controlling means and said recording means.
